(19) United States
(12) Patent Application Publication
(10) Pub. No.: US 2011/0198520 A1
(43) Pub. Date: Aug. 18, 2011

(54) ELECTRICALLY CONTROLLED VALVE ARRANGEMENT FOR A SHOCK ABSORBER

(76) Inventors: Mattias Enstedt, Uppsala (SE); Atsushi Ishii, Upplands Vasby (SE); Geir Lindblad, Marsta (SE)

(21) Appl. No.: 13/002,129

(22) PCT Filed: Jul. 1, 2009
(86) PCT No.: PCT/SE2009/000346

§ 371 Date: Apr. 15, 2011

(30) Foreign Application Priority Data
Jul. 2, 2008 (SE) 0801565-3

(51) Int. Cl. F16K 31/02

(52) U.S. Cl. 251/129.01

(57) ABSTRACT

A valve arrangement for controlling a clamping medium flow between a first (C1) and a second (C2) damping chamber in a hydraulic shock absorber. The invention also relates to a shock absorber having this valve arrangement.

### TECHNICAL FIELD

The invention relates to an adjustable shock absorber device and to an arrangement in such a shock absorber device intended for use on a two-wheeled or four-wheeled vehicle, preferably a motor cycle or an ATV. The damping characteristics of the shock absorber device are determined by an electrically controlled valve arrangement placed in a passage between the two damping chambers of the shock absorber. The electrically controlled valve arrangement allows active adjustment of the damping during travel. The method can be used both in shock absorbers and in front forks.

### BACKGROUND OF THE INVENTION

The prior art within the field is constituted by, for example, EP1781960A2. In this patent specification, a pressurized hydraulic shock absorber is described, comprising a damping-medium-filled damping cylinder divided into two damping chambers, a compression and a return chamber, by a main piston fixed to a piston rod. The pressure in the damping chambers is increased by the fact that a pressurization tank is hydraulically connected to the compression chamber. The flow between the compression chamber and the pressurization tank is adjusted via an electrically controlled valve disposed in a valve housing adjacent to both the damping cylinder and the pressurization tank. The hydraulic flow opening size of the valve is determined by a motor coupled to a needle valve body. The needle valve body delimits a flow opening between the interior of the pressurization tank and the compression chamber. The electric valve comprises, apart from the electric motor and the needle valve body, also a number of other parts.

A further known shock absorber with electrically controlled valve is presented in U.S. Pat. No. 5,431,259. Here a shock absorber is shown, in which the damping medium flow between the two damping chambers of the shock absorber is partially adjusted by the flowing of damping medium through a flow opening whose opening size is determined by an electric-actuator-controlled rotary valve. The electric-actuator-controlled valve is placed adjacent to the damping cylinder in a flow passage extending between the damping chambers.

Since the above-known types of electric valves are made up of a large number of parts, it has proved problematical both to quickly fit the valve in the shock absorber and to update/repair the inner parts of the valve without needing to draw off all the damping medium. It is thus desirable to create a valve which has a compact design and which is sealed off against the valve housing.

### OBJECT OF THE INVENTION

The object of the present invention is to solve the problem of designing an electric valve which is intended for use in a shock absorber and which, with a simple maneuver, can be mounted in the shock absorber without leakage of damping medium or risk of incorrect mounting.

The invention further aims to solve this problem such that individual parts in the electric valve can also be easily exchanged without damping medium in the shock absorber needing to be drawn off.

In addition, the invention aims to help make the valve cheap to produce with a limited number of constituent components and in which the individual parts do not need as large tolerance requirements.

### SUMMARY OF THE INVENTION

The invention relates to a valve arrangement intended to control a damping medium flow between a first and a second damping chamber in a hydraulic shock absorber. At least one of the valve arrangements comprises a first valve including a valve piston which lets through a first damping medium flow and, in series with the first valve, also a second valve comprising an axially movable first valve body. The position of the first valve body in relation to a valve seat is determined by an electrically controlled actuator. The variable flow opening which is formed between the first valve body and the valve seat lets through a second damping medium flow, which is parallel with the first damping medium flow. The invention is characterized in that the actuator and the first valve body are disposed in a separate valve housing. The valve housing has a first valve housing part comprising a substantially cylindrical shell surface and a first and a second housing end, around which there is disposed a first seal, which seals off the damping-medium-filled interior of the shock absorber from the environment. The valve housing also comprises a second valve housing part, which has an axial extent from the first end of the first valve housing part. Mounted on this second valve housing part is the valve piston. The second valve housing part also encloses the damping medium passages, which let through the second damping medium flow running parallel with the first damping medium flow.

By virtue of this design, a valve is created which is easy to remove from and fit in the shock absorber and which is made up of a small number of parts.

Apart from that, it is easy to upgrade a shock absorber having electrically adjusted valves instead of manually adjustable valves. If electrically adjusted valves are used, the damping characteristics of the vehicle can be easily modified—including during travel—by the driver adjusting the control signal which controls the actuator, i.e. the position of the axially movable first valve body, via a control, for example, mounted adjacent to the hands of the driver. The adjustment can also be made automatically with the aid of a more advanced control system with possible sensors.

In a first embodiment, a first part of the damping medium passage is radially disposed in the second valve housing part and a second part of the damping medium passage is axially disposed in the second valve housing part. Where the first and the second passage cross, the valve seat is disposed. The axially movable first valve body extends through a sealed-off first opening in the first end of the valve housing. In the first opening there is also disposed a third valve housing part having an inner second seal, which seals against the movable first valve body, and an outer third seal, which seals against the first valve housing part. As a result of this construction, a control of the axially movable first valve body is obtained, such that the flow opening between the seat and one—preferably conical—end of the first valve body can be accurately adjusted.

In a second embodiment, the actuator is arranged inserted as a unit in the first valve housing part. The actuator comprises in this case a rotary motor, which, via a driver element, converts a rotary motion into a linear motion of the axially movable first valve body.

In a third embodiment, the axially movable first valve body bears against a first end face on the first end of the driver element.

In a fourth embodiment, the axially movable first valve body is produced in the same piece as the driver element, such that they form a single axially movable valve unit.

In a fifth embodiment, the axially movable first valve body is fixed with a coupling part in the driver element.

In embodiments three to five, the driver element is prevented from rotating by the fact that the driver element per se, or the movable valve unit or the coupling part, are locked in the direction of rotation in relation to the valve housing.

When the driver element/the valve unit is locked in the rotational direction in relation to the rotary motor, the rotary motion of the motor is converted into a linear motion. The linear motion of the driver element/the valve unit causes the first valve body to move with the driver element in the axial direction and to create a variable damping medium opening between the seat and the conical end of the valve body. The position of the first valve part in relation to the seat determines the leak flow across the valve arrangement in the shock absorber, and hence also the damping characteristics of the shock absorber, above all in the low-speed range.

The invention also relates to a hydraulic shock absorber comprising a damping cylinder divided by a main piston into a first and a second damping chamber. The damping chambers are connected to a space which is pressurized by an external pressure vessel and through which a damping medium flow passes when it is pressed by the main piston from the first to the second damping chamber, and vice versa. An adjustability of the damping characteristics of the shock absorber is created by the fact that the damping medium also flows between the first and the second damping chamber through a first valve arrangement, which adjusts the damping medium flow in the direction from the first to the second damping chamber, and a second valve arrangement, which adjusts the damping medium flow in the opposite direction. At least one of the valve arrangements is configured as described above.

In a further embodiment of the shock absorber, one of the valve arrangements is without electrical adjustment and is instead adjusted manually.

The invention is described in greater detail below, with references to the accompanying drawings.

### LIST OF FIGURES

FIG. 1 shows a hydraulic shock absorber in cross section.

FIG. 2 shows an alternative embodiment of the valve arrangements.

FIG. 3 shows the second valve in cross section.

FIG. 4 shows a detail of the second valve along the section IV in FIG. 3.

FIG. 5 shows a second embodiment of the second valve in cross section.

FIG. 6 shows a detail of the second valve along the section VI in FIG. 5.

### DETAILED DESCRIPTION OF THE INVENTION

FIG. 1 shows a hydraulic shock absorber 1 in cross section. The shock absorber comprises a damping-medium-filled damping cylinder 2 divided by a main piston 3 into a first C1 and a second C2 damping chamber. The main piston 3 is fixed in a piston rod 4, which in turn is fixed in a wheel suspension part SP movable in a vehicle. The main piston 3 can either be solid, i.e. not let through any damping medium flow, or else a certain flow across the piston through channels disposed in the piston is permitted. The damping cylinder 2 is delimited at its upper end by a delimiting part in the form of a cylinder head 5, which is preferably fastened in the chassis or frame CP of the vehicle. Of course, the piston rod 4 can also be fastened in the chassis/frame CP and the damping cylinder 2 can be fastened in the movable part—the design being characterized in that when the wheel suspension part moves in relation to the chassis/frame, a movement occurs which reduces or increases the volumes of the damping chambers C1, C2.

The shock absorber in FIG. 1 is pressurized with a basic pressure p1 by an external pressure vessel 6 being coupled to the damping-medium-filled damping cylinder 2. The shock-absorber also has a double-tube design, which means that a second tube 7 is disposed around the damping cylinder 2. In the space which is formed between the damping cylinder 2 and the outer tube 7, damping medium is intended to flow when the shock absorber is subjected to movement which means the sizes of the damping chambers vary. Both the first C1 and the second C2 damping chamber are connected to a space C3 pressurized by the external pressure vessel 6. The damping medium flow passes through this pressurized space C3 when pressed by the main piston 3 from the first C1 to the second C2 damping chamber, and vice versa. In order to create an adjustability of the damping characteristics of the shock absorber, the damping medium flows between the first and the second damping chamber through two valve arrangements—a first valve arrangement 8, which adjusts the damping medium flow in the direction from the first to the second damping chamber, and a second valve arrangement 9, which adjusts the damping medium flow in the opposite direction. The valve arrangements are disposed between the pressurized space C3 and the respective damping chamber C1/C2 and are designed such that they limit the flow in the direction from damping chamber to pressurized space and allow an unrestricted flow in the other direction. This means that the pressure in the damping chamber which expands, i.e. acquires a lower pressure than the chamber which is compressed, will always be no less than the basic pressure p1.

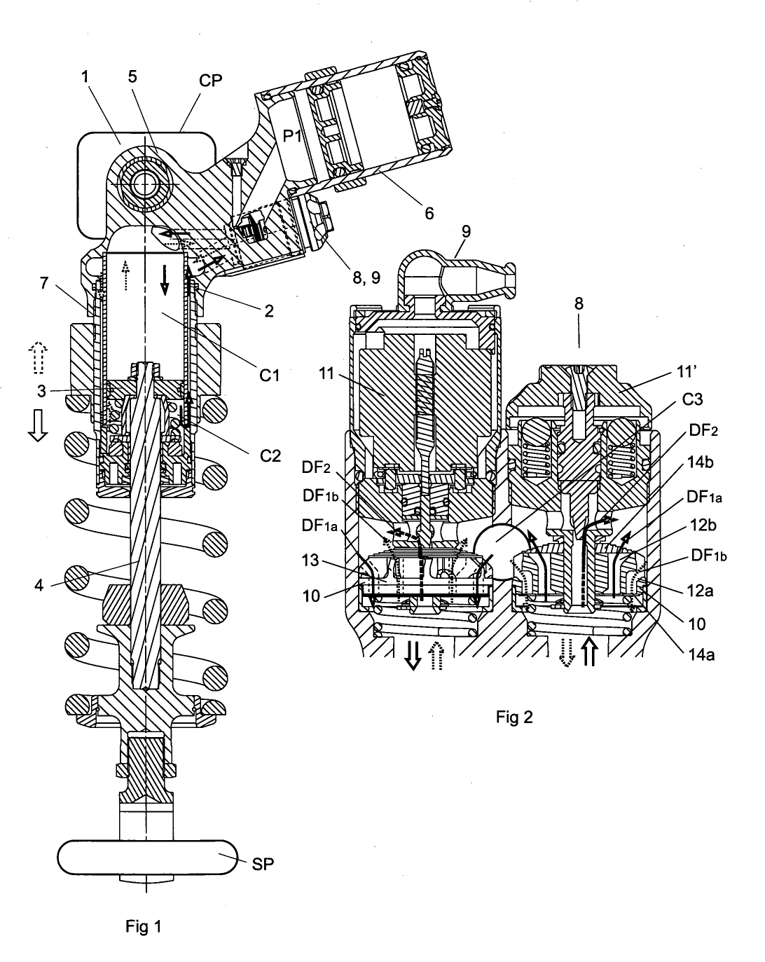

The damping medium flow in the valve arrangements, in FIG. 1 in the direction from the respective damping chamber to the pressurized space, is limited by the fact that it mainly flows through the valve arrangements 8, 9 via at least two passages delimited, respectively, by a first valve 10 and by a second valve 11′, 11 disposed parallel with the first valve. These valves are described in greater detail in FIG. 2. In FIG. 2, the first valve arrangement 8 is constructed according to the prior art without electrical adjustment of the valve characteristics with a second valve 11′, and the second valve arrangement 9 shows an embodiment of the valve 11 according to the invention. The first valve 10 is exchangeable between the two valve arrangements 8, 9 and thus has the same configuration in both cases. Preferably, both valve arrangements 8, 9 are of the same type, but it is also possible to just have one actively controlled valve, as is shown in the figure.

The characteristics of the first valve 10 are preferably determined by a pressure difference created by a damping medium flow through a number of damping channels 12a, 12b which extend through a valve piston 13 and which are delimited by a collection of flexible reed valves 14a, 14b, so-called shims. Given a certain pressure difference across the valve piston 13, these reed valves open in the respective flow direction and let a first damping medium flow DF₁ₐ, DF_{1b} in through the inflow damping channels 12b and out through the outflow damping channels 12b, via the pressurized space C3.

Parallel with this first damping medium flow DF₁ₐ, DF_{1b}, a second damping medium flow DF₂ flows between the damping chambers via the second valve 11. This second flow can be described as a controlled leakage between the damping chambers. This second flow thus determines the damping character of the whole of the shock absorber up to the point where the pressure difference across the valve piston 13 is generated, which opens the flexible reed valves 14a, 14b of the valve piston. Once the reed valves 14a, 14b of the valve piston have opened, some of the damping medium flow will continue to go through the second valve 11, but the main damping function of the shock absorber is then determined by the flexibility of the reed valves 14a, 14b.

The second valve 11 comprises an axially movable first valve body 15, which preferably has a conical configuration at its first end 15a, but can also be configured in some other known manner. The first valve body 15 works against a valve seat 16, so that their relative position creates a variable flow opening. The position of the first valve body 15 is determined by an electrically controlled actuator 17.

The first valve body 15 and the actuator 17 are arranged mounted in a valve housing 18. The valve housing 18 comprises a first 19 and a second valve housing part 20, in which the first valve housing part 19 has a substantially cylindrical shell surface A₁₈ and a first and a second housing end 19a, 19b. Around the shell surface A₁₈ there is disposed a first seal 21, which seals off the damping-medium-filled interior of the shock absorber from the environment. The interior of the shock absorber is represented in FIG. 2 by the chamber C3 of the space pressurized by the tank.

The second valve housing part 20 is a substantially cylindrical part, which extends out from the first end 19a of the first valve housing part. Preferably, the first 19 and the second valve housing part 20 are produced from one and the same piece of material. On the second valve housing part 20 there is mounted the valve piston 13, i.e. the second valve housing part 20 is intended to be a piston holder. The piston 13 is slipped onto the second valve housing part 20 and is held in place by a clip 22 or the like, which is mounted at the outer end 20a of the second valve part.

In the second valve part 20 there is disposed a damping medium passage 23a, 23b, through which the second damping medium flow can pass. The second damping medium flow DF₂ parallel with the first damping medium flow DF₁ thus goes through this passage 23. The damping medium passage has a first part 23a, which can be said to be an inlet channel and which extends axially into the second valve part 20. The damping medium passage also has a second part 23b, which can be said to be an outlet channel 23b. The second damping medium passage part 23b is disposed at the inner end 20b of the second valve part and is configured as one or more radially disposed holes, preferably 1-6 in number.

Where the axially disposed inlet channel 23a and the radially disposed outlet channel(s) 23b intersect, the valve seat 16 is created, against which the first valve body 15 works. The axially movable first valve body 15 has a cylindrical valve body shaft 15b, which extends through a first opening at the first end of the valve housing and into the flow opening of the second valve part. On the first end 15a of the valve body, which emerges in the flow opening, the valve body is conical, to enable the second damping medium flow DF₂ between the seat 16 and the valve body 15a to be easily regulated with an even and predictable speed.

The valve body shaft 15b shall be axially movable in relation to the valve housing 18 without significant friction. At the same time, the interior of the first valve housing part 19 shall be sealed off from the damping medium flowing through the flow opening of the second valve part 20. The valve body shaft 15b extends through a third valve housing part 24, which has at least an inner 25a and an outer seal 25b. This third valve housing part 24 is pressed into the first opening at the first end 19a of the first valve housing part 19 and can move a certain distance in the axial direction without any reduction in sealing capacity. Of course, the third valve housing part 24 can be avoided if a seal is instead placed directly in the first opening in the first valve housing part 19.

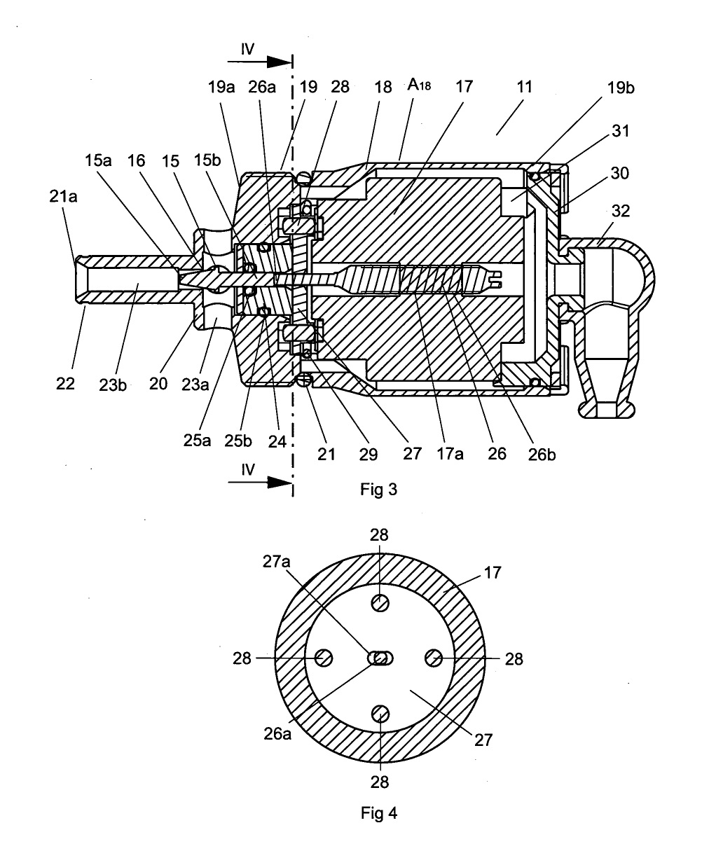

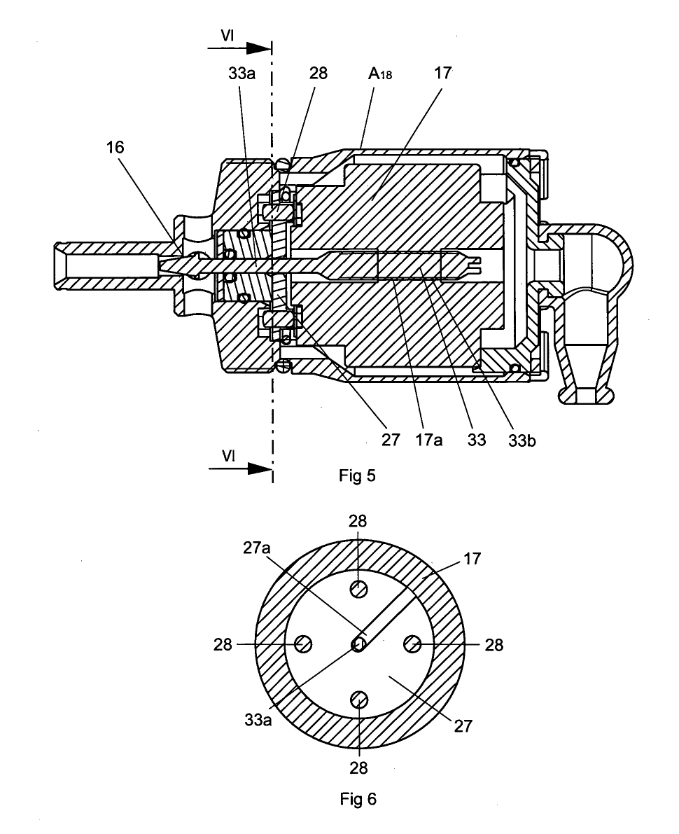

In one embodiment, the third valve housing part 24 can be used to transmit a compressive force created by the pressure in the common pressurized space, in which this force is used to clamp the actuator 17 in the valve housing. The force created by the pressure acts firstly upon the third valve housing part 24, which in turn presses on a washer 27 which is axially movable in the valve housing. The chassis of the actuator 17 is then pressed by the washer 27 against a counterstay 31 disposed at the second end 19b of the first valve housing part. This embodiment is that which is shown in FIGS. 3 and 5.

In FIGS. 3, 5 and 7, the actuator 17 comprises a rotary motor of known construction. Via a driver element 26, the rotary motion of the motor is converted into a linear motion of the axially movable first valve body 15 by the first end 26a of the driver element bearing against a first end face of the first valve body 15. The first valve body 15 then moves with the driver element 26, thereby creating a variable damping medium opening between the seat 16 and the valve body 15. The position of the first valve body 15 in relation to the seat 16 determines the leak flow across the valve arrangement in the shock absorber and hence also the damping characteristics of the shock absorber, above all in the low speed range. The actuator 17 is electrically coupled with a control unit (not shown), which regulates the control signal to the actuator. The control unit can have an adjustment control fastened somewhere on the vehicle, preferably close to the hands of the driver, so that the characteristics of the shock absorber can be adjusted also during travel. Of course, this control signal can also be generated fully automatically from a more advanced control unit.

The driver element 26 comprises an outer thread 26b, which cooperates with an inner thread 17a disposed in the rotary motor. If the driver element 26 is prevented from rotating when the motor 17 rotates, a linear motion of the driver element 26 is instead created.

In the valve construction shown in FIGS. 3 and 5, the rotation of the driver element 26 is prevented by the first end 26a of the driver element being inserted in an asymmetrical oblong hole 27a arranged substantially centered in the washer 27. The washer 27 is also locked in the rotational direction in relation to the valve housing 18 via pins 28, which extend through other holes disposed in the washer and into the valve housing 18. The pins 28 are preferably 1-6 in number. The first end 26a of the driver element has two surfaces, which are plane in the axial direction and which have been created by beveling of the first, essentially circular end 26a. These plane surfaces bear against two plane surfaces in the holes 27a of the washer in order to prevent rotation of the driver element in relation to the rotary motor, see FIG. 4.

The washer 27 also bears against and prevents too great an axial motion of the third valve part 24 in relation to the valve housing 18. Also the axial motion of the washer 27 in relation to the valve housing 18 pressing on the actuator 17 is prevented by the fixing of a single removable support, preferably a locking ring 29, in the housing adjacent to the washer 27.

FIG. 5 shows an embodiment of the invention in which the axially movable first valve body 15 is produced in the same piece as the driver element 26, such that they form an axially movable valve unit 33. The valve body shaft 15b and the first end 26a of the driver element 26 can thus be said to be merged. Thus it is now the valve unit 33 having a conical configuration at its first end 33a which is disposed in the direction of the seat 16. The conical part can also be arranged such that it is removable from the outer part (not shown) of the first end 33a. The valve unit 33 also has an outer thread 33b, which cooperates with the inner thread 17a of the actuator.

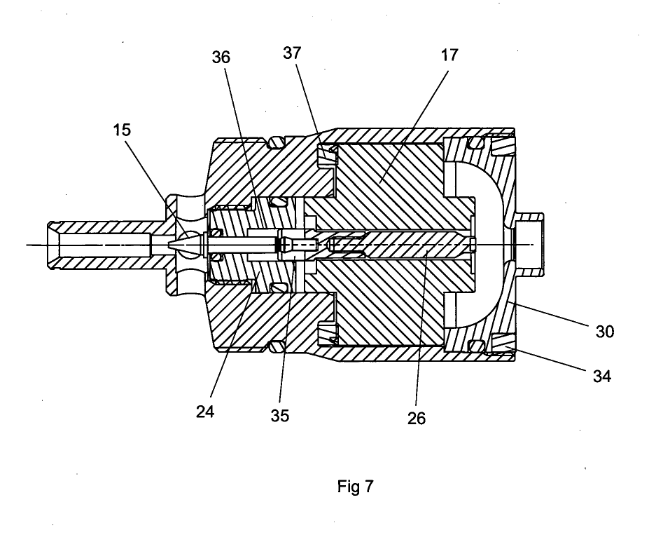

The first end 33a of the valve unit 33 is inserted in an asymmetrical oblong hole 27a disposed in the washer 27. The hole can be shaped as shown in FIG. 4, or the oblong hole 27a can extend all the way out to the outer edge of the washer 27 such that it forms a groove into which the first end 33a of the valve unit can be inserted, see FIG. 6. The first end 26a of the valve unit 33 is preferably also beveled in the axial direction and has two plane, axially extending surfaces, which bear against two plane surfaces in the oblong shaped hole 27a such that the valve unit 33 is rotationally locked in relation to the rotary motor.

FIG. 7 shows a further alternative embodiment of the invention, in which no internal pressure is used to clamp the actuator 17 in the valve housing. Here, a cap 30 is instead used, which is disposed at the second end 19b of the first valve housing part 19 with the task of biasing the actuator. The cap 30 is threaded in place in the valve housing, preferably with a threaded part 34 which presses the cap 30 against an elastic part 37 in the form of an O-ring or the like. The third valve housing part 24 is then arranged fixedly, instead of axially movably, in relation to the first valve housing part 19 and is fixed at the first end 19a of the first valve housing part 19 with a thread or the like. In this embodiment, the washer 27 is also removed. In order to prevent rotation of the driver element in relation to the rotary motor, a coupling part 35 is instead fastened in the driver element. The coupling part 35 can, for example, either be threaded or injection molded onto the driver element 26. If a thread is used, the rotation between the parts is locked with a threaded locking mechanism of some kind. The coupling part 35 is preferably fixed in the first valve body 15 with a snap fastening or the like. The coupling part 35 is inserted in an asymmetrical oblong hole 36 arranged substantially centered in the third valve housing part 24. The coupling part 35 has two surfaces, which are plane in the axial direction and are created by the first, essentially circular end having been beveled. These plane surfaces bear against two plane surfaces in the hole 36 of the third valve housing part in order to prevent rotation of the driver element in relation to the rotary motor.

When the valve arrangements are dismounted, the procedure is started by the initial removal of the cap 30 disposed at the second end 19b of the first valve housing part 19. A special tool is then used to pick out the whole of the valve arrangement 8, 9. Fastened to the cap 30 is also a first part of the protective casing 32 which encloses the electric lead supplying current to the actuator 17. This protective casing can advantageously be snapped off before the dismounting is started. Once the valve arrangement has been picked out, the high speed damping characteristics of the shock absorber can be adjusted by exchanging parts of the reed valves covering the flow passages 12a, 12b of the valve piston 14 so as to alter the rigidity of the full collection of reed valves (shim stack) and hence also the pressure difference at which the stack opens. Mounting of the valve arrangements is realized according to the reverse procedure. Through this type of mounting of the first valve 10 with valve piston 13, it is also easy to upgrade a shock absorber with manually adjusted valve 8 to an electrically controlled valve 9. The valve housing has, in fact, the same external shape as the manually adjusted valve and thus fits in the same cutouts.

The invention is not limited to the embodiment shown by way of example above, but can be modified within the scope of the following patent claims and the inventive concept. For example, the invention can also be used in front forks, shock absorbers and steering dampers which are not pressurized, or which make use of pressurization only in one of the damping chambers.

1. A valve arrangement intended to control a damping medium flow between a first and a second damping chamber (C1,C2) in a hydraulic shock absorber, in which at least one of the valve arrangements comprises a first valve having a valve piston which lets through a first damping medium flow (DF₁ₐ, DF_{1b}) and, parallel with the first valve, a second valve having a first, axially movable valve body, whose position in relation to a valve seat is determined by an electrically controlled actuator and creates between the first valve body and the valve seat a variable flow opening, which lets through a second damping medium flow (DF₂) in the form of a leak flow, wherein the electrically controlled actuator together with the first valve body are disposed in a valve housing having a first valve housing part comprising a substantially cylindrical shell surface (A₁₈) and a first and a second housing end, in which around the shell surface (A₁₈) there is disposed a first seal, which seals off the damping-medium-filled interior of the shock absorber from the environment, and in which the valve housing also comprises a second valve housing part, which extends out from the first end of the first valve housing part and on which the valve piston is mounted, and in which the second valve housing part encloses the damping medium passages, which let through the second damping medium flow (DF₂) running parallel with the first damping medium flow.

2. The valve arrangement as claimed in claim 1, wherein a first part of the damping medium passage is radially disposed in the second valve housing part and a second part of the damping medium passage is axially disposed in the second valve housing part and, where the first and the second passage cross, the valve seat is disposed.

3. The valve arrangement as claimed in claim 1, wherein the axially movable first valve body is arranged passing through a sealed-off opening in the first end of the valve housing.

4. The valve arrangement as claimed in claim 3, wherein in the first opening there is disposed a third valve housing part having an inner second seal, which seals against the movable first valve body, and an outer third seal, which seals against the first valve housing part.

5. The valve arrangement as claimed in claim 3, wherein the actuator is arranged inserted as a unit in the first valve housing part.

6. The valve arrangement as claimed in claim 1, wherein the actuator comprises a rotary motor, which, via a driver element, converts a rotary motion into a linear motion of the axially movable first valve body.

7. The valve arrangement as claimed in claim 6, wherein the axially movable first valve body bears against a first end face on the first end of the driver element.

8. The valve arrangement as claimed in claim 6, wherein the axially movable first valve body is produced in the same piece as the driver element, such that they form an axially movable valve unit.

9. The valve arrangement as claimed in claim 6, wherein the axially movable first valve body is fixed with a coupling part in the driver element.

10. The valve arrangement as claimed in claim 6, wherein the driver element is prevented from rotating by the fact that the driver element is prevented from rotating by the fact that the driver element, or the movable valve unit or the coupling part, is locked in the rotational direction in relation to the valve hosing by virtue of being inserted in an asymmetrical hole.

11. A hydraulic shock absorber comprising a damping cylinder divided by a main piston into a first (C1) and a second (C2) damping chamber, in which an adjustability of the damping characteristics of the shock absorber is created by the fact that the damping medium also flows between the first and the second damping chamber through at least one valve arrangement, which adjusts the damping medium flow in the direction from the first to the second damping chamber, and vice versa, wherein at least one of the valve arrangement is configured according to claim 1.

12. The hydraulic shock absorber as claimed in claim 11, wherein one of the valve arrangements is without electrical adjustment and is instead adjusted manually.
